(19) United States
(12) Patent Application Publication
(10) Pub. No.: US 2013/0139920 A1
(43) Pub. Date: Jun. 6, 2013

(54) Faucet device selectively operatable manually or automatically

(71) Applicant: Hsiang Hung Wang, Changhua Hsien (TW)

(72) Inventor: Hsiang Hung Wang, Changhua Hsien (TW)

(21) Appl. No.: 13/373,805

(22) Filed: Dec. 1, 2011

(51) Int. Cl. F16K 51/00

(52) U.S. Cl. 137/801

(57) ABSTRACT

A faucet device includes a faucet member having a passage and a pathway communicative with a chamber of the faucet member, two hoses coupled to the passage and the pathway of the faucet member, a valve device disposed in the faucet member for mixing hot and cold water into a mixed water and having an exit and an outlet port engaged with the passage and the pathway of the faucet member, a check valve disposed between the hose and the pathway of the faucet member for limiting the mixed water to flow from the pathway of the faucet member to the hose, and a control device is coupled between the hoses to control the mixed water to selectively flow through the hoses or to selectively block the hoses.

### BACKGROUND OF THE INVENTION

1. Field of the Invention

The present invention relates to a faucet device, and more particularly to a faucet device including a structure for allowing hot water and cold water to be suitably or adjustably mixed with each other, and for allowing the faucet device to be selectively operated either manually or automatically.

2. Description of the Prior Art

Various kinds of typical faucet devices have been developed and normally comprise a hot water inlet and a cold water inlet for receiving hot water and cold water respectively and for allowing the hot water and the cold water to be suitably or adjustably mixed with each other, and for allowing an outlet water of a suitable temperature to flow out of or to be supplied out through the faucet device.

For example, U.S. Pat. No. 5,749,393 to Yang, U.S. Pat. No. 5,839,471 to Yang, U.S. Pat. No. 6,029,687 to Chang, and U.S. Pat. No. 6,123,105 to Yang disclose several of the typical faucet devices provided for suitably or adjustably mixing the hot water and the cold water with each other, and a control stem pivotally or rotatably attached or mounted or secured to an outer housing for engaging with the valve member and for controlling and supplying an outlet water having a suitable mixing temperature out through the faucet device.

However, the typical mixing faucet devices may only be operated or actuated manually, but may not be operated or actuated automatically.

U.S. Pat. No. 7,014,166 to Wang, and U.S. Pat. No. 7,389,793 to Wang disclose two further typical water mixing faucet device operatable or actuatable automatically with an electrically operated or actuated solenoid valve.

However, the typical mixing faucet devices should all be switched off and stopped working and may not be worked when the solenoid valve or control device has become failed; i.e., the typical mixing faucet devices may not be used or operated or actuated before the typical mixing faucet devices have been repaired or fixed.

The present invention has arisen to mitigate and/or obviate the afore-described disadvantages of the conventional control structures for the faucet devices.

### SUMMARY OF THE INVENTION

The primary objective of the present invention is to provide a faucet device including a structure for allowing hot water and cold water to be suitably or adjustably mixed with each other, and for allowing the faucet device to be selectively operated either manually or automatically.

In accordance with one aspect of the invention, there is provided a faucet device comprising a faucet member including a chamber formed therein, and including a cold water inlet and a hot water inlet formed therein and communicative with the chamber of the faucet member for supplying a cold water and a hot water into the chamber of the faucet member, and including a passage and a pathway formed therein and communicative with the chamber of the faucet member, and including an outlet mouth formed therein, and including a conduit formed therein and communicative with the pathway and the mouth of the faucet member, a first hose coupled to the passage of the faucet member, a second hose coupled to the pathway of the faucet member, a valve device disposed in the chamber of the faucet member and including two orifices formed therein and engaged with the cold and the hot water inlets of the faucet member respectively for supplying the cold water and the hot water from the water inlets of the faucet member into the valve device and for allowing the hot water and the cold water to be mixed in the valve device into a mixed water, the valve device including an exit and an outlet port formed therein and engaged with the passage and the pathway of the faucet member respectively for selectively supplying the mixed water into either the exit or the outlet port of the valve device, a check valve disposed between the second hose and the pathway of the faucet member for limiting the mixed water to selectively flow from the second hose to the pathway of the faucet member and for preventing the mixed water from flowing from the pathway of the faucet member to the second hose such that the faucet device may be selectively operated manually, and a control device coupled between the first hose and the second hose to control the mixed water to selectively flow through the first and the second hoses and to selectively flow through the check valve and the pathway and the mouth of the faucet member, and to selectively block the first and the second hoses and to limit and prevent the mixed water from flowing through the first and the second hoses even when the mixed water has been supplied to the passage of the faucet member and the first hose automatically.

The control device may be selected from a solenoid valve for controlling the mixed water to selectively flow through the first and the second hoses, and to selectively block the first and the second hoses. A spout may further be provided and attached to the mouth of the faucet member for supplying the mixed water out of the faucet member.

A sensor may further be provided and electrically coupled to the control device for detecting a moving of a user toward the faucet member, and for selectively actuating the control device when the user moves toward the faucet member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a faucet device in accordance with the present invention;

FIG. 2 is a partial rear plan schematic view of the faucet device, in which a portion of the outer faucet housing has been cut off for showing the inner structure of the faucet device;

FIG. 3 is a partial cross sectional view of the faucet device taken along lines 3-3 of FIG. 2, illustrating the operation of the faucet device; and

FIG. 4 is another partial cross sectional view of the faucet device taken along lines 4-4 of FIG. 2, illustrating the operation of the faucet device.

### DETAILED DESCRIPTION OF THE PREFERRED EMBODIMENT

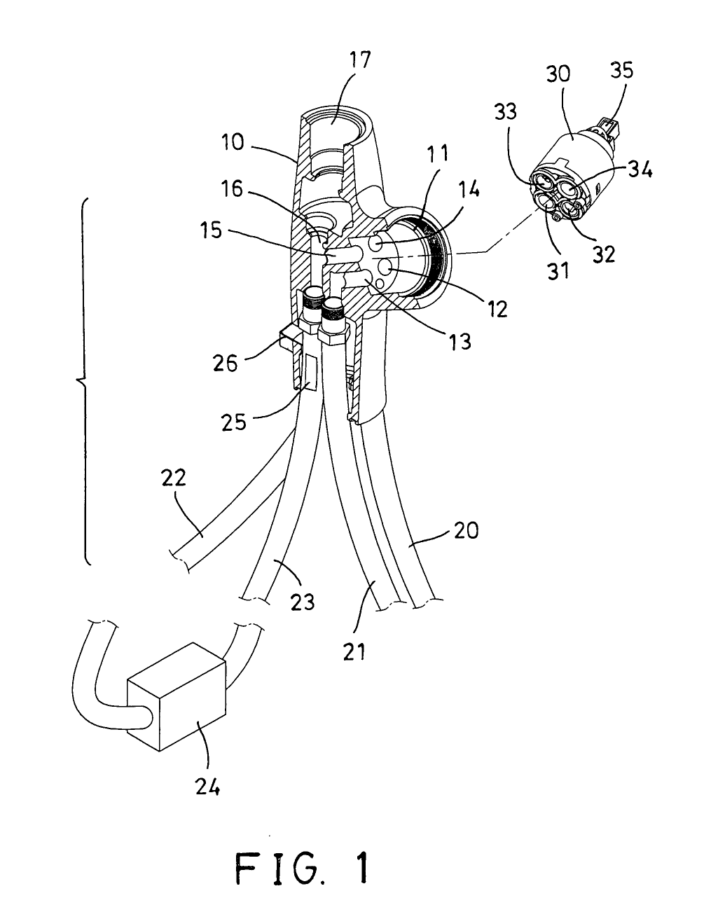

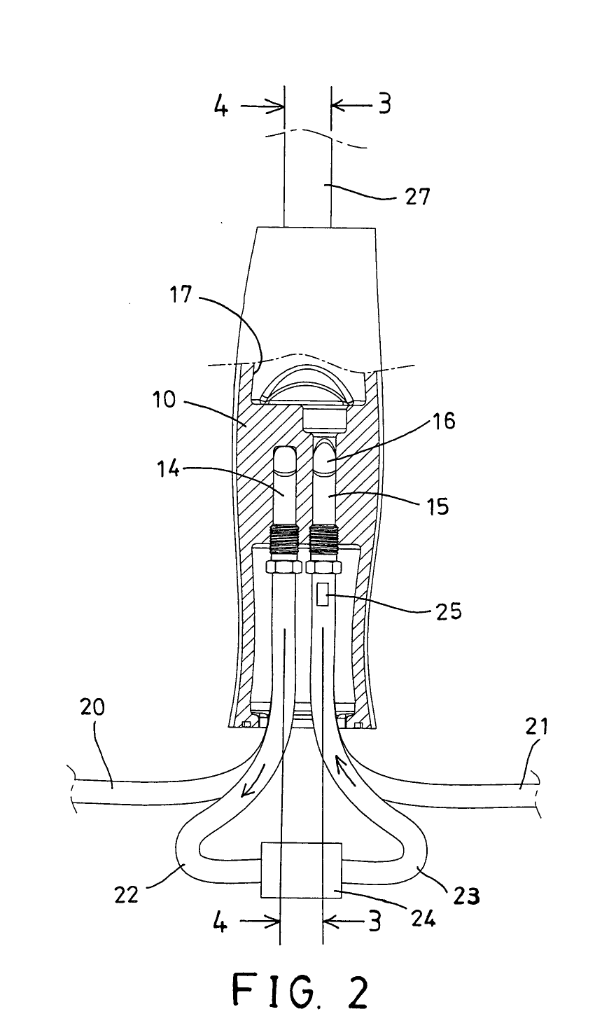

Referring to the drawings, and initially to FIGS. 1 and 2, a faucet device in accordance with the present invention comprises an outer faucet housing or faucet body or member 10 including a chamber 11 formed therein and opened forwardly, and including a first or cold water inlet 12 and a second or hot water inlet 13 formed therein and communicative with the chamber 11 of the faucet member 10 and coupled to two pipes 20, 21 respectively for coupling to cold and hot water reservoirs respectively (not shown) and for receiving the cold water and the hot water from the cold and hot water reservoirs respectively, and for allowing the hot water and the cold water to be selectively supplied into and/or mixed in the chamber 11 of the faucet member 10.

The faucet member 10 further includes a passage 14 and a pathway 15 formed therein and communicative with the chamber 11 of the faucet member 10 and offset from the water inlets 12, 13, and further includes a conduit 16 formed therein and communicative with the pathway 15 of the faucet member 10, and further includes an outlet port or mouth 17 formed therein and communicative with the conduit 16 of the faucet member 10 for selectively supplying the mixed water out through the outlet port or mouth 17 of the faucet member 10. Two hoses 22, 23 are coupled to the passage 14 and the pathway 15 and/or the conduit 16 of the faucet member 10, and coupled together or to a control means or device 24, such as a solenoid valve 24.

The control means or device or solenoid valve 24 may be used to control the water flowing through the hoses 22, 23 for allowing the water to selectively flow through the hoses 22, 23, or to selectively block the hoses 22, 23 and to prevent the water from flowing through the hoses 22, 23. For example, a detector or sensor 26 may further be provided and attached or mounted or secured or coupled to the faucet member 10 and electrically connected or coupled to the solenoid valve 24 wirelessly or with electric wires or cables (not shown) for detecting the moving of a user toward or to the faucet member, and for selectively actuating or operating the solenoid valve 24 to control the water to selectively flow through the hoses 22, 23 when the user moves toward or to the faucet member, or to selectively block the hoses 22, 23. A faucet element or spout 27 is attached or mounted or secured or coupled to the mouth 17 of the faucet member 10 for selectively supplying the mixed water out through the faucet member 10.

A check valve 25 is disposed or engaged into the hose 23 or the pathway 15 or the conduit 16 of the faucet member 10 or disposed or engaged between the hose 23 and the pathway 15 or the conduit 16 of the faucet member 10 for limiting the water to selectively flow from the hose 23 to the pathway 15 and/or the conduit 16 of the faucet member 10 and for preventing the water from flowing from the pathway 15 and/or the conduit 16 of the faucet member 10 to the hose 23; i.e., the water received or contained in the pathway 15 and/or the conduit 16 of the faucet member 10 is allowed to selectively supply and flow out through the outlet port or mouth 17 of the faucet member 10 only, but may not flow from the faucet member 10 into the hose 23. The water is allowed to selectively flow out through the check valve 25 and the conduit 16 and the mouth 17 of the faucet member 10 only when the solenoid valve 24 is actuated or operated to control the water to selectively flow through the hoses 22, 23.

A valve device 30 is provided or disposed or engaged into the chamber 11 of the faucet member 10 and includes two entrance orifices 31, 32 formed therein and aligned with or engaged with the water inlets 12, 13 of the faucet member 10 respectively for receiving the cold water and the hot water from the water inlets 12, 13 of the faucet member 10 respectively and for allowing the hot water and the cold water to be selectively supplied into and/or mixed in or by or with the valve device 30. The valve device 30 further includes an exit 33 and an outlet port 34 formed therein and aligned with or engaged with the passage 14 and the pathway 15 of the faucet member 10 respectively for selectively supplying the mixed water out through either the exit 33 or the outlet port 34 of the valve device 30.

Several examples of the valve devices 30 have been disclosed in the cited prior arts which may be taken as the references for the valve device 30. The valve device 30 further includes a valve shank or switching or control knob 35 for switching or controlling the mixed water to selectively flow out through either of the exit 33 or the outlet port 34 of the valve device 30; i.e., the valve device 30 may switch and control the mixed water to selectively flow out through the exit 33 and the outlet port 34 of the valve device 30, and then to selectively flow into the passage 14 and the pathway 15 of the faucet member 10 respectively, and then to selectively flow out through the mouth 17 of the faucet member 10.

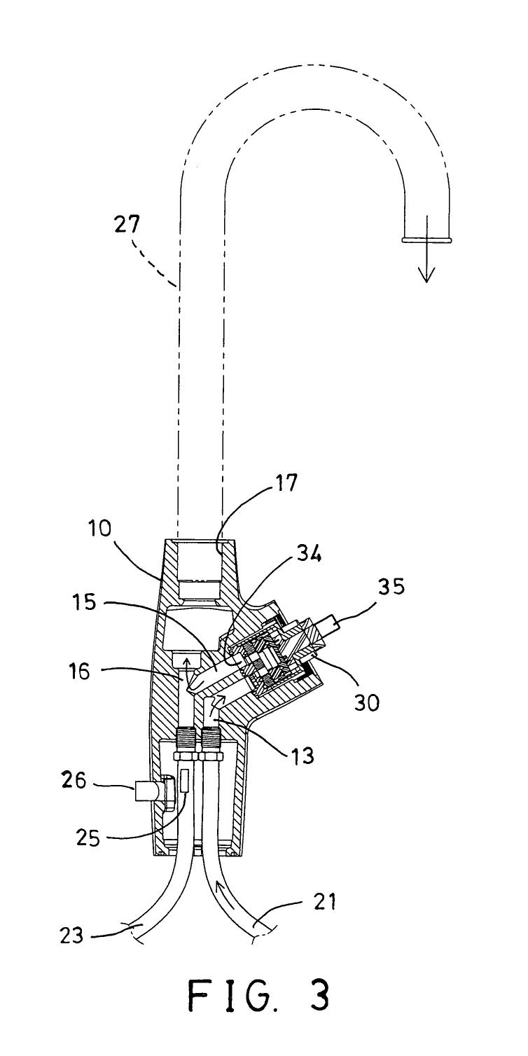

In operation, as shown in FIG. 3, when the control knob 35 of the valve device 30 is actuated or operated to control and supply the mixed water out through the outlet port 34 of the valve device 30, the water is now allowed to selectively flow into the pathway 15 and the conduit 16 of the faucet member 10 and is allowed to selectively supply and flow out through the outlet port or mouth 17 of the faucet member 10 and the spout 27. At this moment, the check valve 25 may control and limit the water to prevent the water from flowing from the pathway 15 and/or the conduit 16 of the faucet member 10 to the hose 23, and for allowing the water received or contained in the pathway 15 and/or the conduit 16 of the faucet member 10 to selectively supply and flow out through the outlet port or mouth 17 of the faucet member 10 only. At this moment, the faucet device in accordance with the present invention may be operated manually.

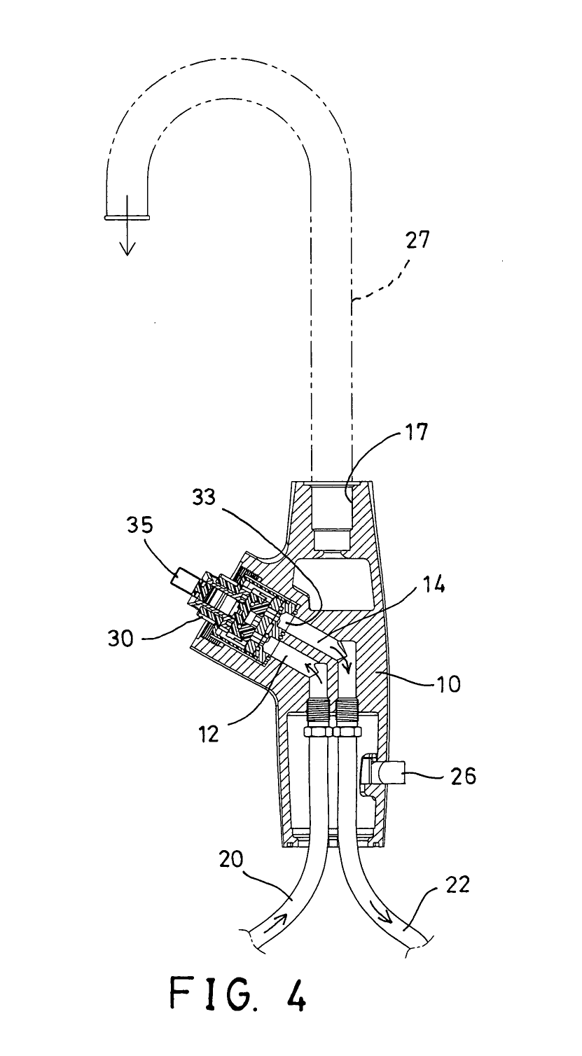

As shown in FIG. 4, when the control knob 35 of the valve device 30 is actuated or operated to control and supply the mixed water out through the exit 33 of the valve device 30, the water is now allowed to selectively flow into the passage 14 of the faucet member 10 and then to selectively flow into the hose 22. The solenoid valve 24 may now be used to control the water flowing through the hoses 22, 23 and for allowing the water to selectively flow through the hoses 22, 23 and then to selectively flow out through the check valve 25 and the conduit 16 and the mouth 17 of the faucet member 10 and then to selectively flow out through the spout 27. The solenoid valve 24 may also be used to selectively block the hoses 22, 23 and to prevent the water from flowing through the hoses 22, 23 and to prevent the water from flowing out through the check valve 25 and the conduit 16 and the mouth 17 of the faucet member 10 and the spout 27. At this moment, the faucet device in accordance with the present invention may be operated automatically with the solenoid valve 24.

Accordingly, the faucet device in accordance with the present invention includes a structure for allowing hot water and cold water to be suitably or adjustably mixed with each other, and for allowing the faucet device to be selectively operated either manually or automatically.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A faucet device comprising:
a faucet member including a chamber formed therein, and including a cold water inlet and a hot water inlet formed therein and communicative with said chamber of said faucet member for supplying a cold water and a hot water into said chamber of said faucet member, and including a passage and a pathway formed therein and communicative with said chamber of said faucet member, and including an outlet mouth formed therein, and including a conduit formed therein and communicative with said pathway and said mouth of said faucet member,
a first hose coupled to said passage of said faucet member,
a second hose coupled to said pathway of said faucet member,
a valve device disposed in said chamber of said faucet member and including two orifices formed therein and engaged with said cold and said hot water inlets of said faucet member respectively for supplying the cold water and the hot water from said water inlets of said faucet member into said valve device and for allowing the hot water and the cold water to be mixed in said valve device into a mixed water, said valve device including an exit and an outlet port formed therein and engaged with said passage and said pathway of said faucet member respectively for selectively supplying the mixed water into either said exit or said outlet port of said valve device,
a check valve disposed between said second hose and said pathway of said faucet member for limiting the mixed water to selectively flow from said second hose to said pathway of said faucet member and for preventing the mixed water from flowing from said pathway of said faucet member to said second hose, and
a control device coupled between said first hose and said second hose to control the mixed water to selectively flow through said first and said second hoses and to selectively flow through said check valve and said pathway and said mouth of said faucet member, and to selectively block said first and said second hoses and to prevent the mixed water from flowing through said first and said second hoses.

2. The faucet device as claimed in claim 1, wherein said control device is selected from a solenoid valve.

3. The faucet device as claimed in claim 1 further comprising a sensor electrically coupled to said control device for detecting a moving of a user toward the faucet member, and for selectively actuating said control device when the user moves toward said faucet member.

4. The faucet device as claimed in claim 1 further comprising a spout attached to said mouth of said faucet member for supplying the mixed water out of said faucet member.
